(19) United States
(12) Patent Application Publication
(10) Pub. No.: US 2025/0366453 A1
(43) Pub. Date: Dec. 4, 2025

(54) Hand-grip for a Fishing Rod

(71) Applicant: Paul Heyer, Garden City, NY (US)

(72) Inventor: Paul Heyer, Garden City, NY (US)

(73) Assignee: Paul Heyer, Garden City, NY (US)

(21) Appl. No.: 18/831,069

(22) Filed: Jun. 3, 2024

(51) Int. Cl. A01K 87/08

(52) U.S. Cl. CPC A01K 87/08

(57) ABSTRACT

A flat sheet like material sized and shaped to wrap around the handle portion of a fishing pole, as well as wrap around a stem of a reel attached to the handle portion of the fishing pole. The handgrip is preferably a single piece of cushion material. The handgrip has a rod portion for wrapping around the handle portion, and a stem portion for wrapping around the stem. The handgrip has a nub on an opposite side of the handle portion to cover an area where the stem meets the handle portion. Fasteners are provided for keeping the handle portion wrapped around the handle, and the stem portion wrapped around the stem. The size and shape of the handgrip preventing direct contact between the hand of the fisherman, and the pole handle and real stem.

### FIELD OF THE INVENTION

The present invention relates to the portion of a fishing rod and reel that is held by the hand of the fisherman, and in particular, to providing a more comfortable grip of the rod and reel.

### BACKGROUND OF THE INVENTION

A fishing reel holds the fishing line in a wound arrangement and has devices to pay out and retrieve the line. The fishing reel is attached to a fishing rod. The fishing rod has the reel attached to one end of the rod (the handle end portion) and guides the line to the other end. This allows, among other functions, the fisherman to adjust how much line extends from the pole. By gripping the handle end portion of the rod, the fisherman is able to swing the rod to further cause a weight on the hook end of the line to pay out in a motion called casting.

The reel has a stem which attaches to the handle portion of the rod, and the rod has attachment structure for fixing the stem to the handle portion. The fisherman usually holds the handle portion in his/her palm with his/her fingers curling around the handle portion. The stem is usually arranged between the fingers and extends radially outward relative to the rod.

The attachment structure and stem is usually a hard material to provide sufficient support, and also usually has edges or curves with small radii. Fishermen often spend a long time holding and swinging the rod/reel and this can be uncomfortable.

### SUMMARY AND OBJECT OF THE INVENTION

It is an object of the present invention to provide a hand grip material between the hand holding the fishing pole, and the fishing pole in itself, in order to provide a more comfortable grip between the hand and the pole. The material of the hand grip has properties to soften the hard edges and surfaces of the fishing pole, and to possibly also provide thermal insulation between the hand and the pole.

The present invention accomplishes this objective by the hand-grip having a rod portion formed of a flexible, flat material having a softness greater than a softness of the rod handle. The rod portion has a size, shape and flexibility configured to wrap around the rod handle.

The hand-grip also has a stem portion formed of a flexible, flat material having a softness greater than a softness of a stem of the reel. The stem portion has a size, shape and flexibility configured to wrap around the stem of the reel.

A connection section connects the stem portion to the rod portion. The connection section has a size, shape and flexibility configured have the rod portion wrap around the rod handle while the stem portion is wrapped around the stem of the reel.

The size of the rod portion is configured to prevent direct contact between the rod handle and a hand of a user holding the rod handle. The size of the stem portion is configured to prevent direct contact between the stem of the reel and the hand of a user holding the stem of the reel.

The size of the rod portion is configured to have a first rod section overlap or abut a second rod section when the rod portion is wrapped around the rod handle. The size of the stem portion is configured to have a first stem section overlap or abut a second stem section when the stem portion is wrapped around the stem.

A rod portion connector is configured to connect the first and second rod sections when the rod portion is wrapped around the rod handle. The rod portion connector can be one of a hook and loop fastener, a snap fastener, and a sewn fastener.

A stem portion connector configured to connect the first and second stem sections when the stem portion is wrapped around the stem. The stem portion connector can be one of a hook and loop fastener, a snap fastener, and a sewn fastener.

The rod portion has a first direction and has a first dimension in the first direction. The first dimension is equal to or greater than a circumference of the rod handle. The rod portion has a second direction perpendicular to the first direction. The rod portion has a rod edge extending in the second direction.

The stem portion has a first dimension in the first direction and a second dimension in the second direction. The second dimension being equal to or greater than a circumference of the stem of the fishing reel.

The connection section extends from the rod edge in the first direction. The connection section has a dimension in the second direction that is less than the second dimension of the rod portion and the wrap portion.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a side view showing the reel seat portion of a fishing rod with a spinning reel mounted to it before a removable hand grip of the present invention is applied;

FIG. 2 is a top/outside view which shows the basic hand grip uninstalled from the rod handle and laid out in a flat configuration to show its outline with the rod handle underneath;

FIG. 3 is a bottom/inside view which shows the basic hand grip placed on top of the rod handle and laid out in a flat configuration prior to wrapping around the rod handle;

FIG. 4 is an end view of the grip taken along line IV-IV in FIG. 3 to show its sheet like construction;

FIG. 5 is a radial section view of the grip during the wrapping process to show the attachment method of the present invention to the rod and reel;

FIG. 6 is a longitudinal section view of the grip during the wrapping process with the rod handle wrapped, and before the stem is wrapped;

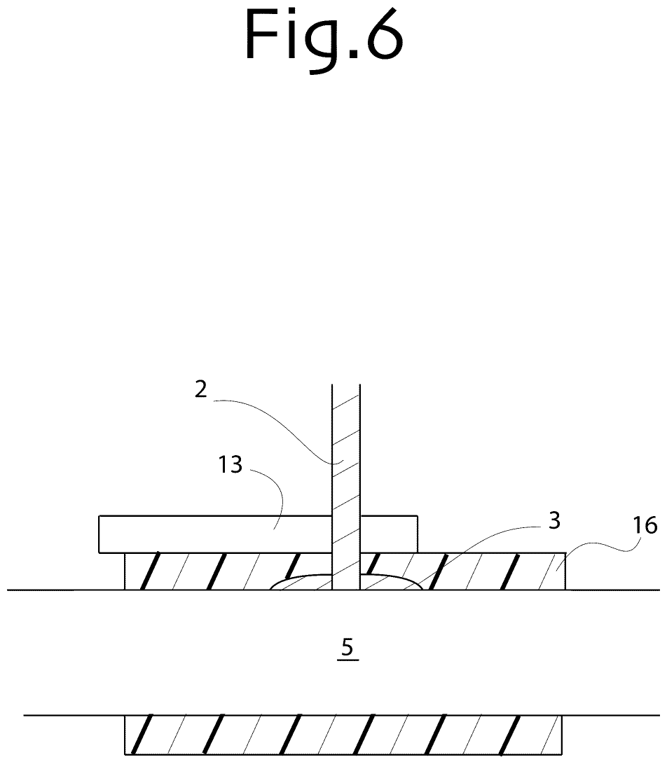

FIG. 7 is a radial section view along line VII-VII in FIG. 10 showing just the rod handle wrapped, and the attachment of the rod portion edges to each other to hold the rod portion on the rod handle;

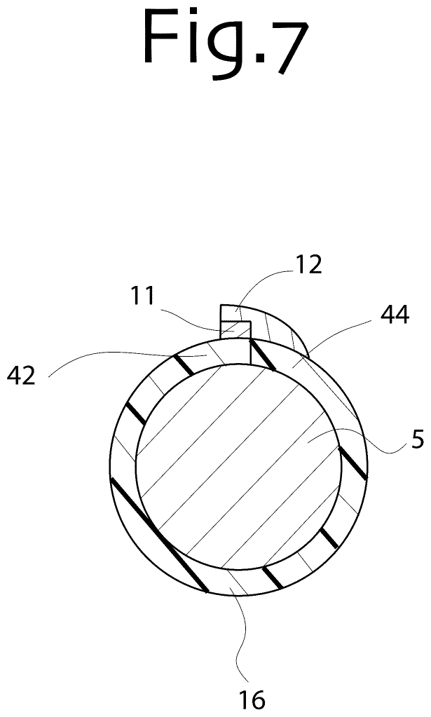

FIG. 8 is a top/outside view of the hand grip with attachment structure for keeping the hand grip wrapped and attached to the rod handle and stem;

FIG. 9 is a bottom/inside view of the hand grip with attachment structure for keeping the hand grip wrapped and attached to the rod handle and stem;

FIG. 10 is a view showing the reel seat portion of a fishing rod with a stem portion of spinning reel mounted to it, and the removable hand grip of the present invention mounted on the rod handle;

FIG. 11 is an end view of the rod handle, reel and the hand grip assembled;

FIG. 12 is a top/outside view of a second embodiment of the stem portion;

FIG. 13 is a bottom/inside view of the second embodiment of the stem portion; and

FIG. 14 is a longitudinal section view of the grip during the wrapping process with the rod handle wrapped, and before the stem is wrapped of the second embodiment of the stem portion.

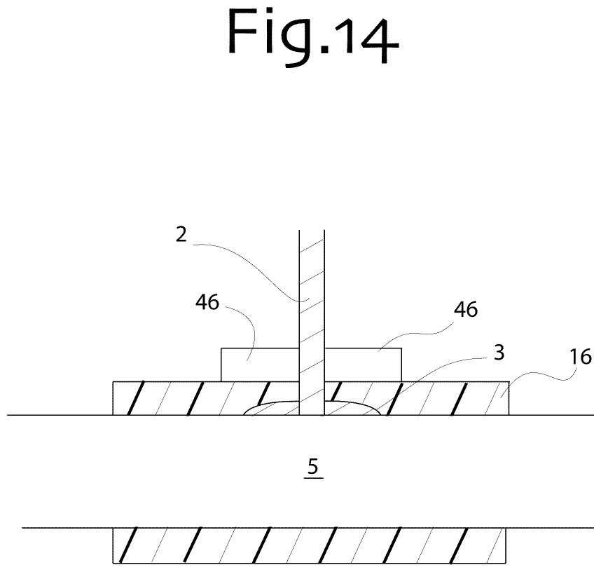

### DETAILED DESCRIPTION OF DRAWINGS

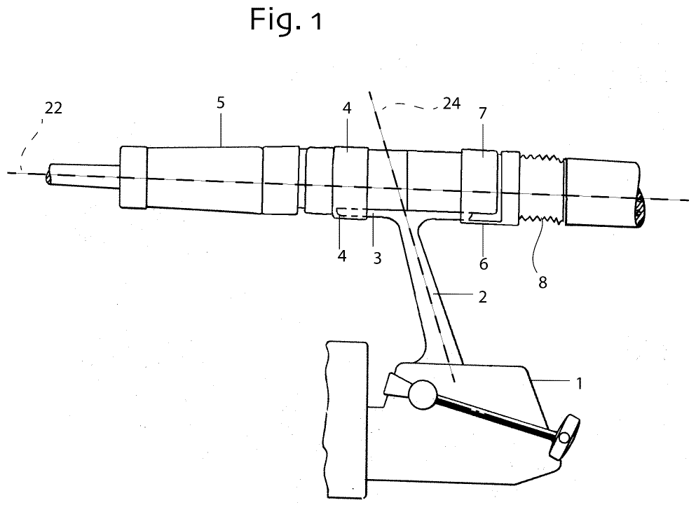

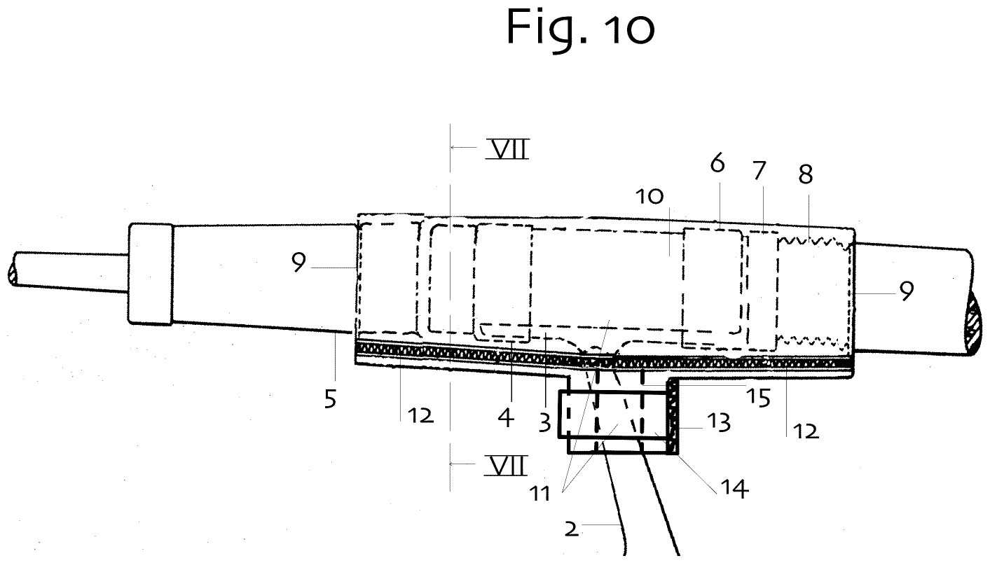

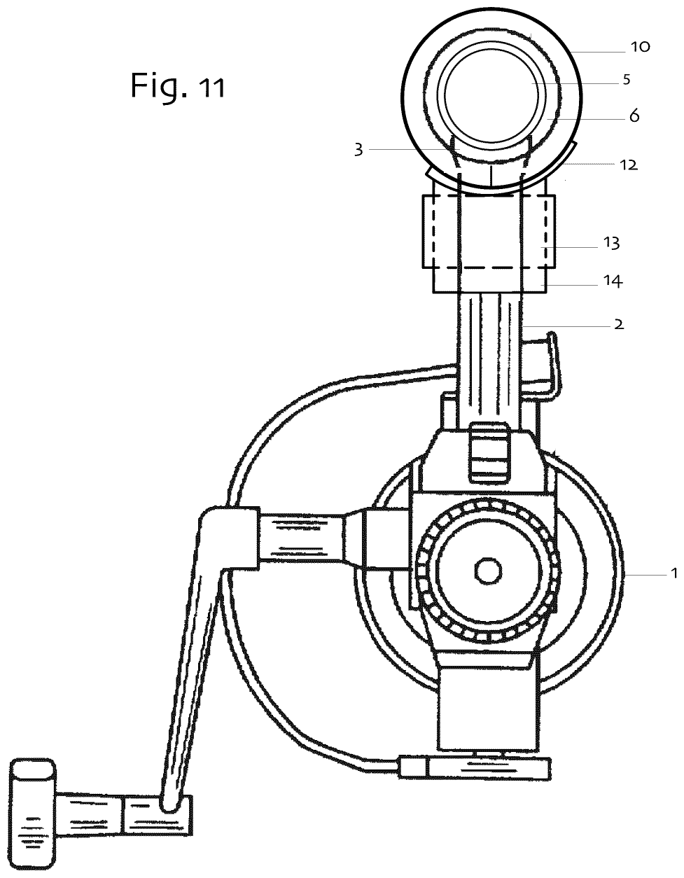

With reference to the drawings, especially FIG. 1, a fishing rod handle 5 mounts a reel 1, a spinning reel in this embodiment, by way of a reel base 3 and stem 2. The rod handle 5 in FIG. 10 is shown covered by a removable hand grip 10 of the present invention. The rod handle 5 includes a reel seat whose components secure a base 3 of the reel 1 to the rod handle 5. The reel seat includes a fixed attachment ring 4 encircling the rod handle 5 and having an enlarged portion 4a that receives one end of the reel base 3. The other end of the reel base 3 is received within an enlarged portion 6 of a second attachment ring 7 that also encircles the rod handle 5. Second attachment ring 7 is slidable along the rod handle 5 to engage with the base 3. The second attachment ring 7 is adjustably movable and selectively axially fixable to the rod handle 5, and thus permits the reel base 3 to be fixed and released from the attachment rings 6, 7, and the rod handle 5. The second attachment ring 7 of the reel seat is threaded onto a threaded portion 8 of the reel seat so that the second attachment ring 7 can be moved axially in either longitudinal direction of the rod handle 5 by the second attachment ring 7 being rotated. The second attachment ring 7 is moved toward the fixed attachment ring 4 to engage the reel base, and securely clamp the reel base 3 between the two attachment rings 6, 7 upon mounting of the reel 1. The mounting or demounting of the reel 1 is done with the hand grip 10 removed from the handle. FIGS. 10 and 11 show the hand grip 10 applied to the rod handle 5 and the reel 1.

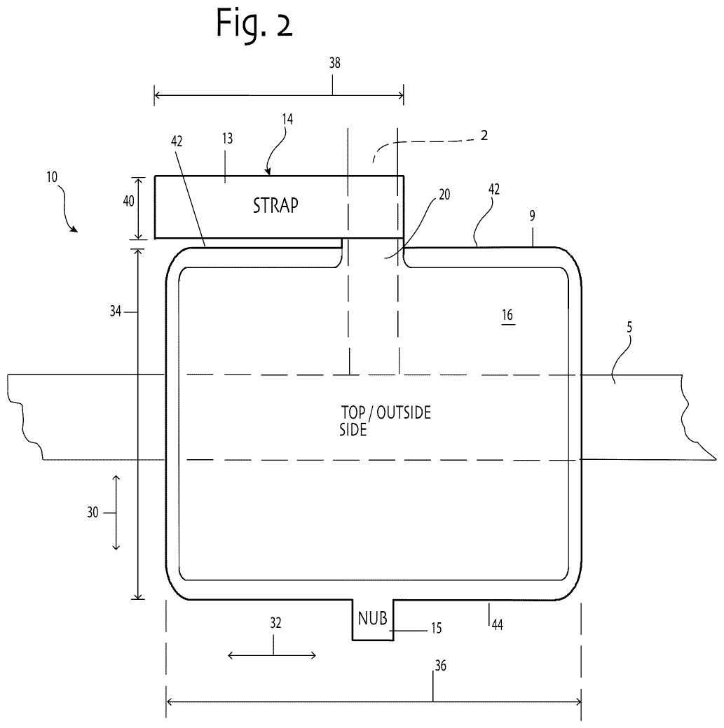

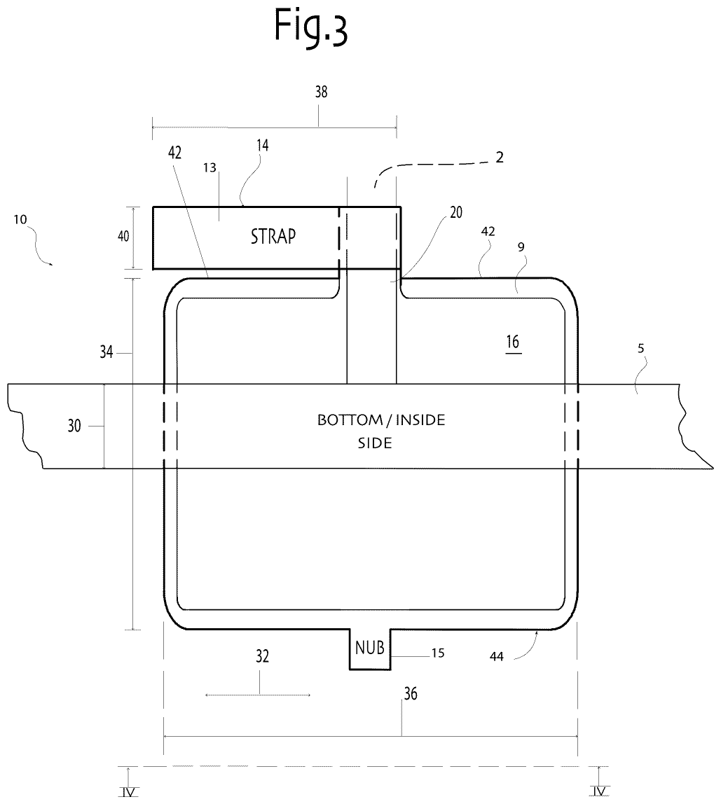

With reference to FIGS. 2 and 3, the hand grip 10 of the present invention has a generally sheet like construction and is made from a soft rubbery flexible sheet like material. The flexible sheet like material is softer than the rod handle 5 in order to make the rod handle 5 more comfortable to hold by the hand of the user. Any material softer than the rod handle 5, the stem 2 or the base 3 an be used. Some of the preferred materials are cushion material, open or closed cell foam, gel, encapsulated gel, cloth and/or a combination of all them. The hand grip 10 of the present invention has an edge banding 9 sewn around all sides.

The hand grip 10 has a rod portion 16 and a stem portion 14. The rod portion 16 is generally rectangular, and has a size, shape and flexibility configured to wrap around the rod handle 5. The size of the rod portion 16 is configured to prevent direct contact between the rod handle 5 and a hand of a user holding the rod handle 5.

The hand grip 10 has the stem portion 14 for wrapping around the stem 2 of the reel 1. The stem portion 14 has a strap portion 13 having a size, shape and flexibility configured to wrap around the stem 2 of the reel 1. The size of the stem portion 14 is configured to prevent direct contact between the stem 2 and the hand of a user holding the rod handle 5 and reel 1.

The hand grip 10 has a connection section 20. The connection section 20 connects the stem portion 14 to the rod portion 16. The connection section 20 is smaller than the stem portion 14 and the rod portion 16 because the stem portion 14 and the rod portion 16 wrap around different axis that are in different directions. The connection section 20 therefore has to flex significantly.

The rod handle 5 has a rod axis 22, FIG. 1. The rod portion 16 wraps around the rod handle about the rod axis 22. The stem 2 has a stem axis 24, FIG. 1, and the stem portion 14 wraps around the stem 2 about the stem axis 24. Because the rod portion/grip 16 is curved about a different axis than the stem portion 14, the connection section 20 has to be smaller than the rod portion 16 and the stem portion 14.

FIG. 2 shows the hand grip 10 with a basic representation of the rod handle 5 behind or under the hand grip 10. FIG. 3 shows the hand grip 10 with a basic representation of the rod handle 5 in front of, or on top of, the hand grip 10. The hand grip 10 and rod handle 5 are initially arranged as shown in FIGS. 2 and 3 prior to wrapping the hand grip 10 around the rod handle 5.

The rod portion 16 has a first direction 30 and has a first handle dimension 34 in the first direction 30. The first handle dimension 34 being preferably equal to or greater than a circumference of the rod handle 5. The rod portion 16 having a second direction 32 perpendicular to the first direction 30, and a second handle dimension 36. The second handle dimension 36 having a length to extend, by the axial length, or greater, of the user's hand on the handle, in the second direction 32, to prevent direct contact between the rod handle 5 and the hand of the user holding the rod handle 5 and reel 1.

The stem portion 14 has a first stem dimension 40 in the first direction 30 and a second stem dimension 38 in the second direction 32. The second stem dimension 38 being equal to or greater than a circumference of the stem 2 of the reel 1. The first stem dimension 40 having a length extending the width of the fingers of the hand holding the stem 2 in the first direction 30, or greater, in order to prevent direct contact between the stem 2 and the fingers of the user holding the rod handle 5 and reel 1.

The connection section 20 extends from a first rod edge 42 in the first direction 30. The connection section 20 having a dimension in the second direction 32 that is less than the second dimension 36 of the rod portion 16 and the dimension 38 of the stem portion 14.

On the opposite side of the rod portion from first rod edge 42 there is a second rod edge 44. From this second rod edge 44 extends a nub 15. The nub 15 is diametrically opposite the stem portion 14 with respect to the major portion of the rod portion 16. The nub 15 also covers the stem 2, especially where the stem 2 meets the rod handle 5, but on the diametrically opposite side of the stem 2 from the connection section 20. The nub 15 helps fully cover where the stem 2 meets the rod handle 5. The nub 15 is for tucking under the stem portion 14 when the rod portion 16 is installed on the rod handle 5, and the strap portion 13 is wrapped around the stem 2. This nub 15 provides closure of the hand grip 10 where the hand grip 10 meets the stem portion 2.

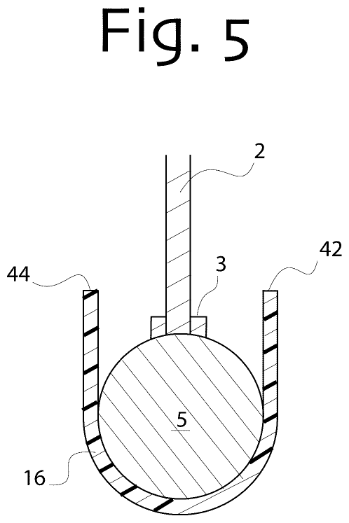

To wrap the hand grip 10 around the rod handle 5 and the reel 1, the hand grip 10 is placed on the rod handle 5 and reel 1 as shown in FIG. 3. The rod portion 16 is bent around the rod handle as shown in FIG. 5. Rod portion edges 44 and 42 are then joined together. The two rod portion edges 42 and 44 can be joined by hook and loop fasteners, snaps, adhesives, straps, or any other appropriate structure.

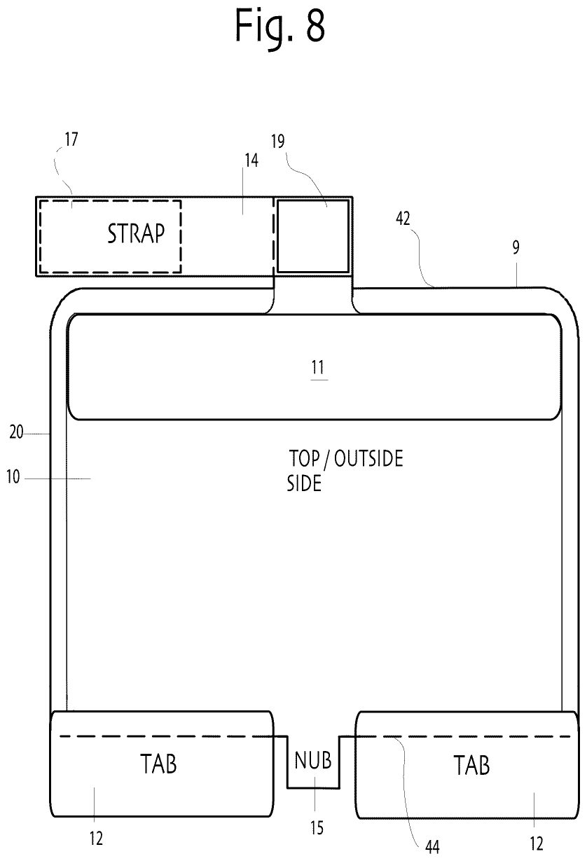

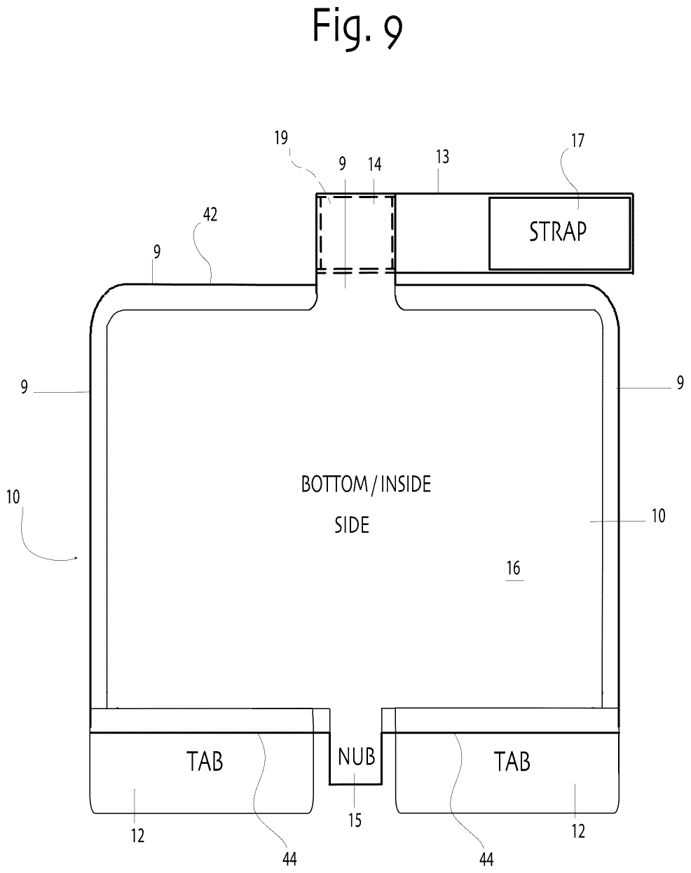

Attaching with hook and loop fasteners are a preferred embodiment and shown in FIGS. 8-10. One of the hook and loop material 11 is attached to the rod portion 16 in the area close to the first rod edge 42.

The other of the hook and loop fasteners 12 is attached closer to the second rod edge 44, and is preferably in the form of a tab. When the rod portion 16 is wrapped around the rod handle 5, the rod edges 42 and 44 are brought adjacent to each other, or overlap each other, and the hook and loop material 11, 12 are overlapped and fastened to one another.

In the preferred embodiment as shown in FIG. 8, the fastener 11 is attached to the rod portion 16 within the boundary of the rod portion 16. The fastener 12 has a part extending away from second rod grip edge 44, so this part of tab 12 can overlap fastener 11 and thus fasteners 11 and 12 can be joined together to hold the rod portion 16 wrapped around the rod handle 5.

Once the rod portion 16 is wrapped around the rod handle 5, the stem portion 14 is preferably wrapped around the stem 2. The connection section 20 is placed against the stem 2 where the stem 2 meets the rod handle 5. The strap 13 of the stem portion 14 is then wrapped/bent around the stem 2 and then fastened to itself with stem portion fasteners 17 and 19. The fastening of the strap portion can be done by hook and loop fasteners, snaps, adhesive, straps, or any other appropriate structure.

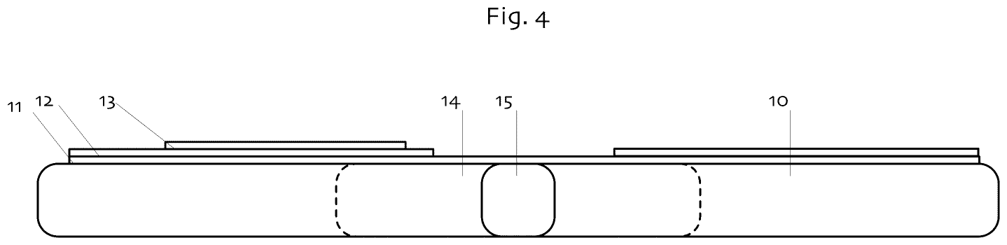

FIG. 4 is a side view of the hand grip 10 from the bottom of FIGS. 2 and 3, and shows the hand grip main material 10, loop material 11, overlapping hook material 12, strap 13, stem portion 14, and nub15.

With reference to FIGS. 10 and 11 which show a section of the reel seat 8 on the rod handle 5 where the spinning reel 1 is mounted to the rod handle 5, the hand grip 10 is wrapped around the rod handle 5 and secured to its corresponding sides by tabs 12 with hook material.

With additional reference to FIG. 11 which shows a section of the reel seat 8 on the rod handle 5 where the spinning reel 1 is mounted to the rod handle 5, the stem portion 14 of hand grip 10 is wrapped around the reel stem 2, and secured to its corresponding side by strap 13 with hook material and loop material on the stem portion 14 and/or on the strap 13.

While the stem portion 14 can be separate from the rod portion 16, it is preferable that the two be connected. Connecting the stem and rod portion 14, 16 makes it easier to store the hand grip when not mounted on the rod handle 5. Connecting the stem and rod portions 14, 16 also prevents the stem portion 14 from sliding away from the rod portion 16 and expose the stem 2 to the fingers of the hand holding the rod handle 5. The connection section 20 connects the stem portion 14 to the rod portion 16.

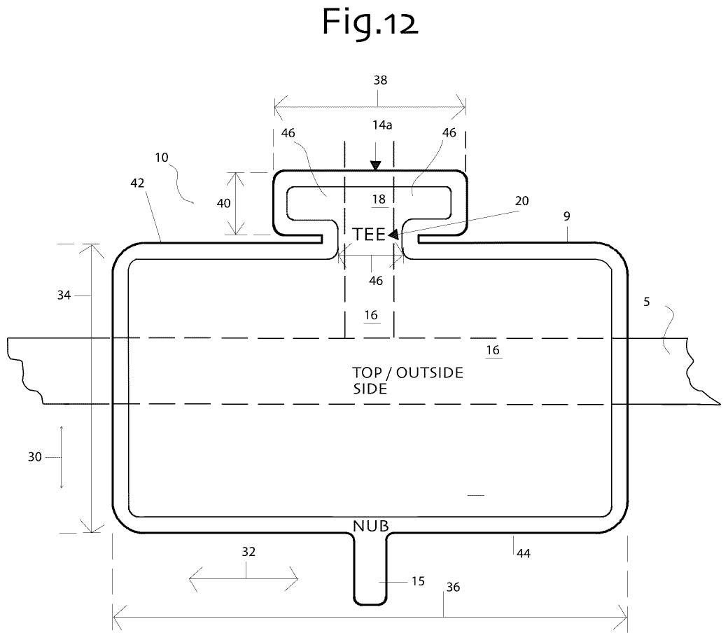

FIG. 12 shows a second embodiment of the stem portion as a T shaped portion 14a. The hand grip 10 has the T portion 14a for wrapping around the stem 2 of the reel 1. The T shaped portion 14a has a T top portion 18 having a size, shape and flexibility configured to wrap around the stem 2 of the reel 1. The size of the T top portion 18 is configured to prevent direct contact between the stem 2 and the hand of a user holding the rod handle 5 and reel 1.

The Tee shaped portion 14a has a connection section 20. The connection section 20 connects the T top portion 18 to the rod portion 16. The connection section 20 is smaller than the stem portion 18 and the rod portion 16 because the T top portion 18 and the rod portion 16 wrap around different axes that are approximately perpendicular. The connection section 20 therefore has to flex significantly.

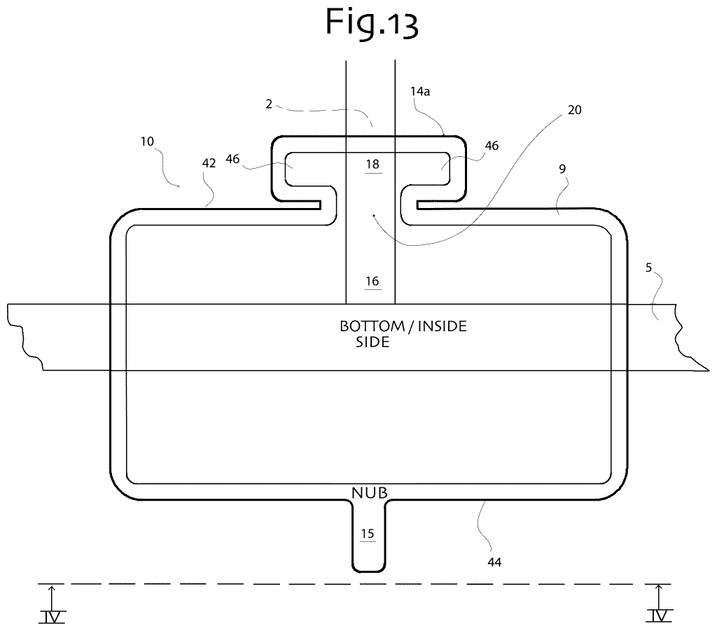

FIG. 12 shows the hand grip 10 with a basic representation of the rod handle 5 behind or under the hand grip 10. FIG. 13 shows the hand grip 10 with a basic representation of the rod handle 5 in front of, or on top of, the hand grip 10. The hand grip 10 and rod handle 5 are initially arranged as shown in FIGS. 12 and 13 prior to wrapping the hand grip 10 around the rod handle 5.

To wrap the hand grip 10 around the rod handle 5 and the reel 1, the hand grip 10 is placed on the rod handle 5 and reel 1 as shown in FIG. 13. The rod portion 16 is bent around the rod handle as shown in FIG. 5. Rod portion edge 44 and 42 are then joined together.

Once the rod portion 16 is wrapped around the rod handle 5, the T shaped portion 14a is preferably wrapped around the stem 2. The connection section 20 is placed against the stem 2 where the stem 2 meets the rod handle 5. The wings 46 of the T shaped portion 14a are then wrapped/bent around the stem 2 in opposite directions to meet on the side of the stem 2 opposite the connection section 20. The wings 46 are then fastened to each other. The fastening of the wings 46 can be done by hook and loop fasteners, snaps, adhesive, straps, or any other appropriate structure.

While specific embodiments of the invention have been shown and described in detail to illustrate the application of the principles of the invention, it will be understood that the invention may be embodied otherwise without departing from such principles.

### LIST OF REFERENCES

1 spinning reel
2 handle of reel and stem
3 base of reel
4 attachment ring
5 rod handle
6 attachment ring
7 adjustment ring
8 threaded portion
9 edge banding
10 hand grip
11 rod portion loop material
12 rod portion hook material
13 strap
14 stem portion—strap embodiment
14a stem portion-T embodiment
15 nub
16 rod portion/grip
17 stem portion loop material
18 T top portion
19 stem portion hook material
20 connection section
22 rod axis
24 stem axis
26 stem portion first direction—along stem long axis
28 stem portion second direction—circumferential
30 rod portion first direction
32 rod portion second direction
34 rod handle first dimension
36 rod handle second dimension
38 stem portion first dimension—
40 stem portion second dimension—
42 first rod portion edge
46 connection section second dimension
44 second rod edge
46 wings of the T-shape

1. A detachable hand-grip for a rod handle of a fishing rod/fishing reel combination, the hand-grip comprising:
a rod portion formed of a flexible, flat material having a softness greater than a softness of the rod handle, said rod portion having a size, shape and flexibility configured to wrap around the rod handle;
a stem portion formed of a flexible, flat material having a softness greater than a softness of a stem of the reel, said stem portion having a size, shape and flexibility configured to wrap around the stem of the reel;
a connection section connecting said stem portion to said rod portion, said connection section having a size, shape and flexibility configured have said rod portion wrap around the rod handle while said stem portion is wrapped around the stem of the reel.

2. The detachable hand-grip in accordance with claim 1, wherein:
said size of said rod portion is configured to prevent direct contact between the rod handle and a hand of a user holding the rod handle;
said size of said stem portion is configured to prevent direct contact between the stem of the reel and the hand of a user holding the stem of the reel.

3. The detachable hand-grip in accordance with claim 1, wherein:
said size of said rod portion is configured to to have a first rod section overlap or abut a second rod section when said rod portion is wrapped around the rod handle;
said size of said stem portion is configured to have a first stem section overlap or abut a second stem section when said stem portion is wrapped around the stem.

4. The detachable hand-grip in accordance with claim 1, further comprising:
a rod portion connector configured to connect said first and second rod sections when said rod portion is wrapped around the rod handle;
a stem portion connector configured to connect said first and second stem sections when said stem portion is wrapped around the stem.

5. The detachable hand-grip in accordance with claim 1, wherein:
said rod portion connector is one of a hook and loop fastener, a snap fastener, and a sewn fastener.
said stem portion connector is one of a hook and loop fastener, a snap fastener, and a sewn fastener.

6. The detachable hand-grip in accordance with claim 1, wherein:
said rod portion has a first direction and has a first dimension in said first direction, said first dimension being equal to or greater than a circumference of the rod handle, said rod portion having a second direction perpendicular to said first direction, said rod portion being configured to wrap around the rod handle, said rod portion having a rod edge extending in said second direction;
said stem portion has a first dimension in said first direction and a second dimension in said second direction, said second dimension being equal to or greater than a circumference of the stem of the fishing reel;
said connection section extends from said rod edge in said first direction, said connection section having a dimension in said second direction that is less than said second dimension of said rod portion.

7. A detachable hand-grip for a rod handle of a fishing rod/fishing reel combination, the handgrip comprising:
a rod portion formed of a flexible, flat material having a softness greater than a softness of the rod handle, said rod portion having a first direction and having a first dimension in said first direction, said first dimension being equal to or greater than a circumference of the rod handle, said rod portion having a second direction perpendicular to said first direction, said rod portion being configured to wrap around the rod handle, said rod portion having a rod edge extending in said second direction;
a stem portion formed of a flexible flat material having a softness greater than a softness of a stem of said reel, said stem portion having a first dimension in said first direction and a second dimension in said second direction, said second dimension being equal to or greater than a circumference of the stem of the fishing reel;
a connection section extending from said rod edge in said first direction, said connection section connecting said stem portion to said rod edge of said rod portion, said connection section having a dimension in said second direction that is less than said second dimension of said rod portion and said stem portion.
